(19) United States
(12) Patent Application Publication
(10) Pub. No.: US 2026/0167142 A1
(43) Pub. Date: Jun. 18, 2026

(54) AIRBAG

(71) Applicant: TOYODA GOSEI CO., LTD., Kiyosu-shi (JP)

(72) Inventors: Masashi HOTTA, Kiyosu-shi (JP); Akihiro Nukaya, Kiyosu-shi (JP); Yusuke Kawamura, Kiyosu-shi (JP)

(21) Appl. No.: 19/395,316

(22) Filed: Nov. 20, 2025

(30) Foreign Application Priority Data
Dec. 18, 2024 (JP) 2024-221817

(51) Int. Cl. B60R 21/203; B60R 21/235

(52) U.S. Cl. CPC B60R 21/2035; B60R 21/235; B60R 2021/23576

(57) ABSTRACT

An airbag mounted on a steering wheel including a grip portion gripped by an occupant and a boss portion connected to a steering shaft of a vehicle, the airbag being inflated by being supplied with an inflation gas, and covering an entire area of the grip portion from behind when the airbag is completely inflated, the airbag that is completely inflated including: an occupant-side panel disposed on a rear side and configured to receive the occupant; a steering wheel-side panel disposed on a front side and supported in contact with the grip portion; and a side panel sewn to the occupant-side panel and the steering wheel-side panel and connecting the occupant-side panel and the steering wheel-side panel, in which a width of the side panel in a front-rear direction along a rotation axis of the steering shaft is larger than a width of the occupant-side panel in a left-right direction.

### CROSS-REFERENCE TO RELATED APPLICATIONS

The present application claims priority from Japanese Patent Application No. 2024-221817 of Hotta et al., filed on December18, 2024, the disclosures of which are hereby incorporated into the present application by reference.

### BACKGROUND

### TECHNICAL FIELD

The present invention relates to an airbag mounted on a steering wheel of a vehicle.

### DESCRIPTION OF RELATED ART

Conventionally, as described in JP 2024-121558 A, a configuration in which an airbag is mounted on a steering wheel of a vehicle and an occupant is received and protected by the airbag in a collision of the vehicle is widely known.

In the shape of the airbag that is completely inflated described in JP 2024-121558 A, the width in the left-right direction is larger than the width in the front-rear direction. In such a configuration, in a case where the weight of the occupant is heavy or the speed at the time of collision of the vehicle is high, the airbag is deformed so that the width in the front-rear direction is greatly reduced by the forward load input to the airbag when the occupant is received, and so-called bottoming in which the occupant comes into contact with a grip portion of the steering wheel with the airbag interposed therebetween is likely to occur.

### SUMMARY

An object of the present invention is to provide an airbag capable of preventing an occupant from coming into contact with a grip portion of a steering wheel with the airbag interposed therebetween in a collision of a vehicle.

A typical configuration of the airbag according to the present invention for solving the above problem is as follows.

An airbag mounted on a steering wheel including a grip portion gripped by an occupant and a boss portion connected to a steering shaft of a vehicle, the airbag being inflated by being supplied with an inflation gas, and covering an entire area of the grip portion from behind when the airbag is completely inflated, the airbag that is completely inflated including:

an occupant-side panel that is disposed on a rear side and is configured to receive the occupant;

a steering wheel-side panel that is disposed on a front side and is supported in contact with the grip portion; and

a side panel that is sewn to the occupant-side panel and the steering wheel-side panel and connects the occupant-side panel and the steering wheel-side panel,

in which a width of the side panel in a front-rear direction along a rotation axis of the steering shaft is larger than a width of the occupant-side panel in a left-right direction.

### BRIEF DESCRIPTION OF THE DRAWINGS

FIG. 1 is a view of a periphery of a driver's seat of a vehicle equipped with an airbag device as viewed from the left side;

FIG. 2 is a front view of a steering wheel of the vehicle;

FIG. 3 is a cross-sectional view of the steering wheel taken along line A-A illustrated in FIG. 2;

FIG. 4 is a left side view of the steering wheel in a state where the airbag is completely inflated;

FIG. 5 is a front view of the steering wheel in a state where the airbag is completely inflated;

FIG. 6 is a plan view of each panel constituting the airbag; and

FIG. 7 is a plan view of the steering wheel in a state where the airbag is completely inflated.

### DESCRIPTION OF THE PREFERRED EMBODIMENTS

Preferred embodiments of the present invention are described below with reference to accompanying drawings. However, the invention is not limited to the embodiments disclosed herein. All modifications within the appended claims and equivalents relative thereto are intended to be encompassed in the scope of the claims.

Hereinafter, a configuration of an airbag 50 according to an embodiment of the present invention will be described with reference to the drawings. The airbag 50 is mounted on a steering wheel 10 of a vehicle 30. Note that the dimensions, materials, shapes, relative arrangements, and the like of the components in the following description are not intended to limit the scope of the present invention only to them unless otherwise specified.

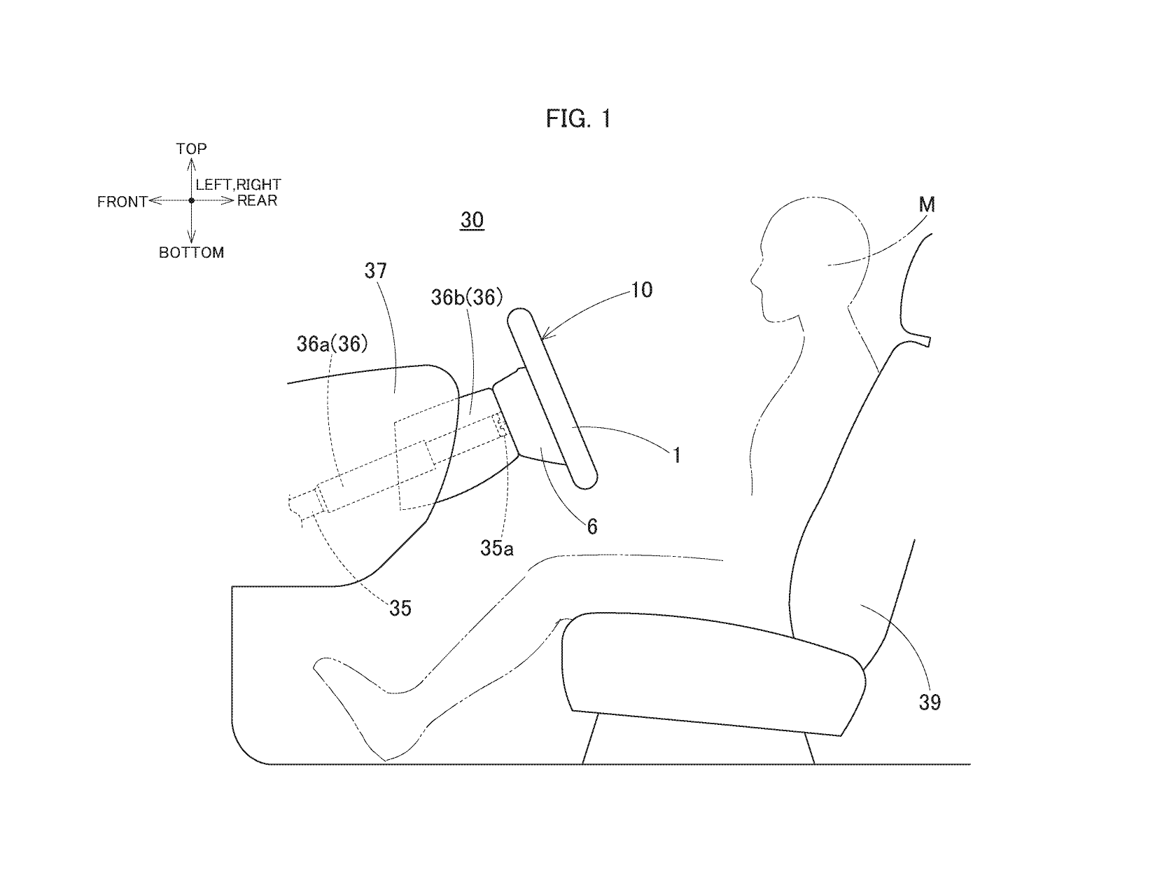

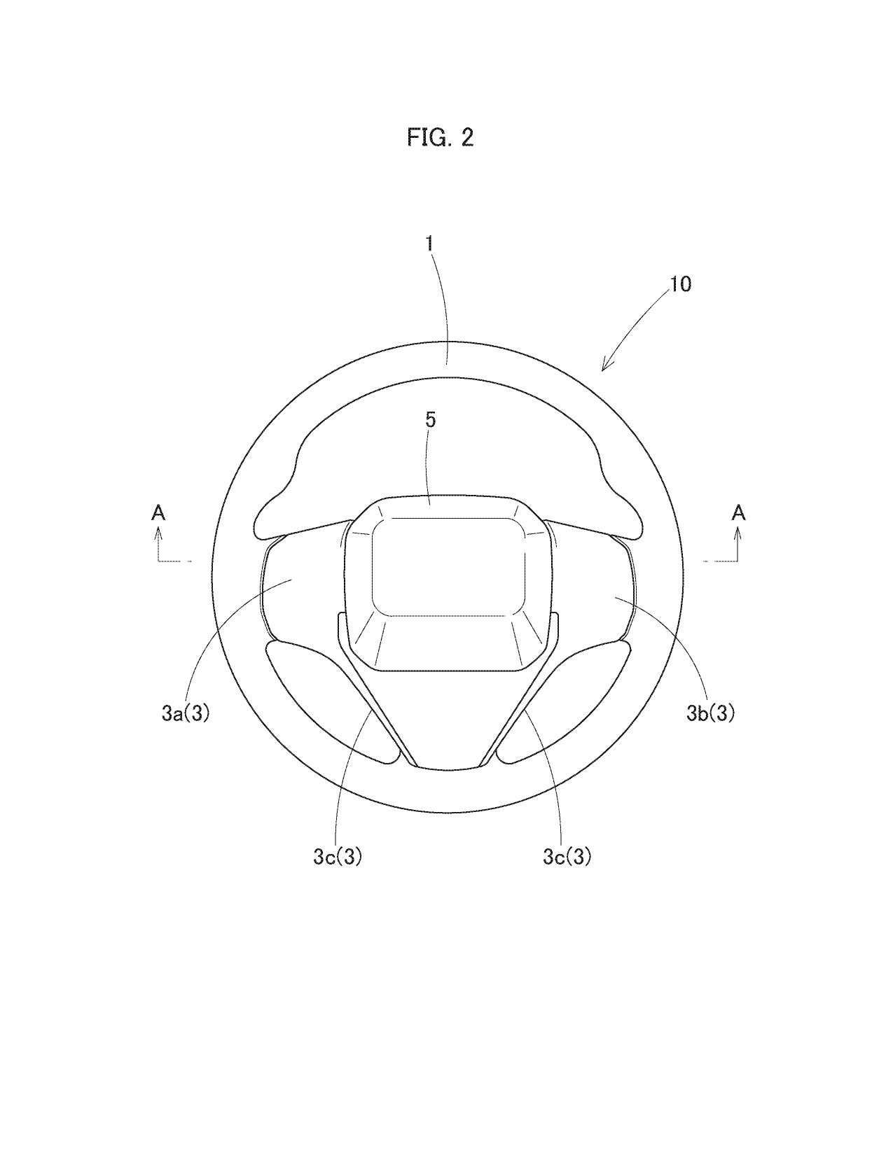

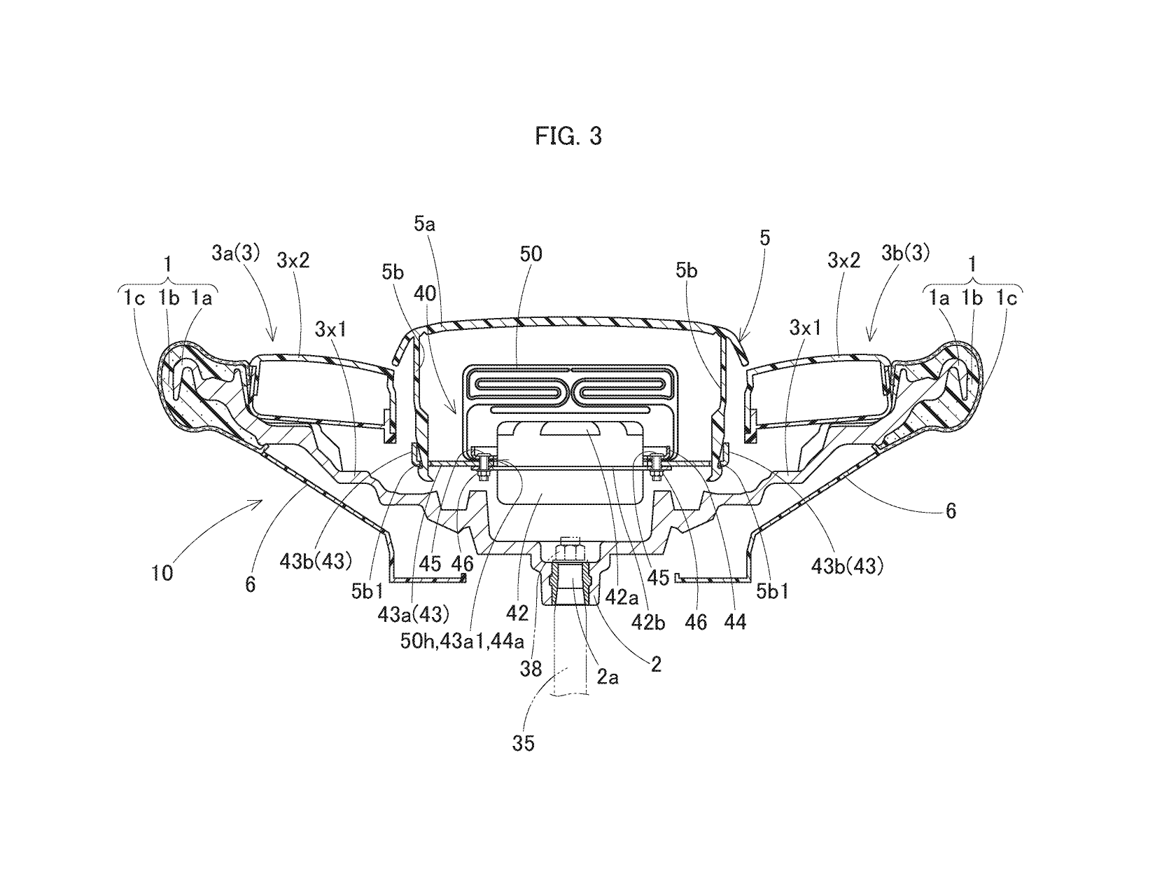

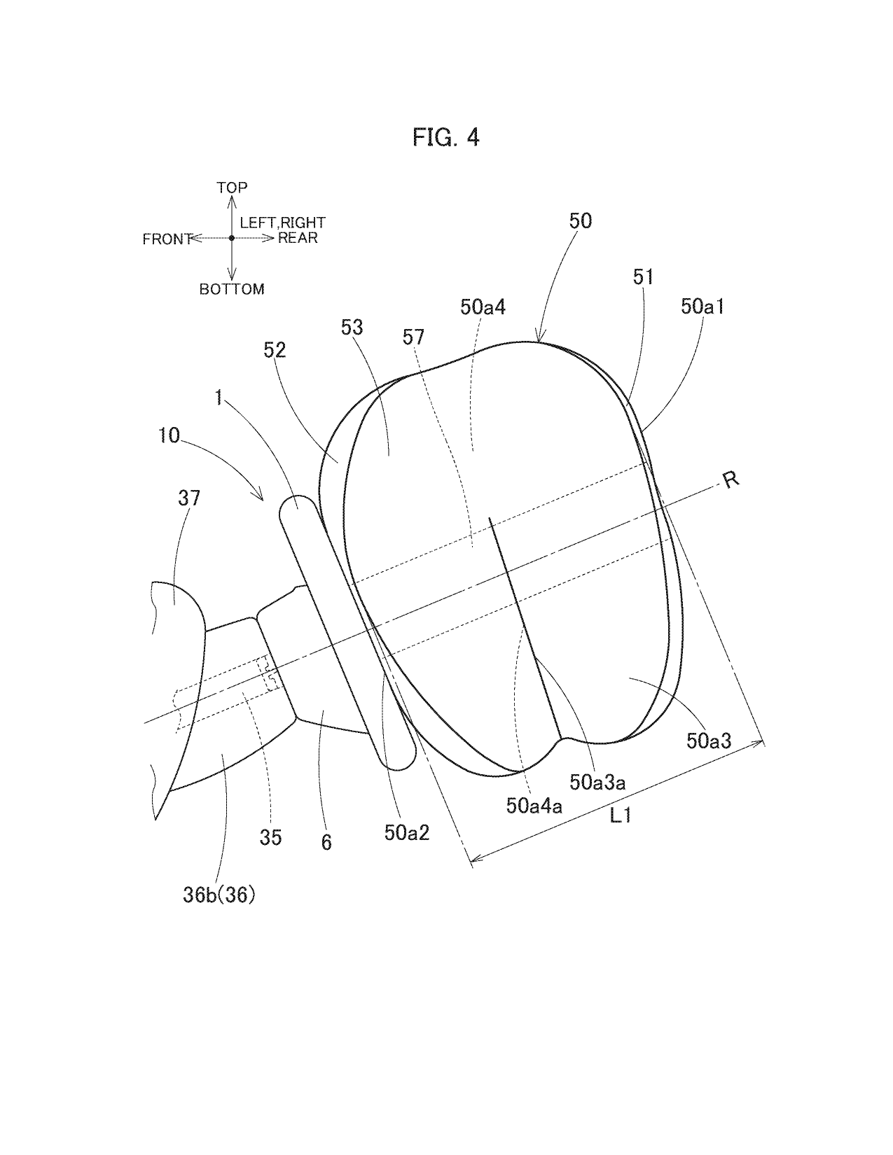

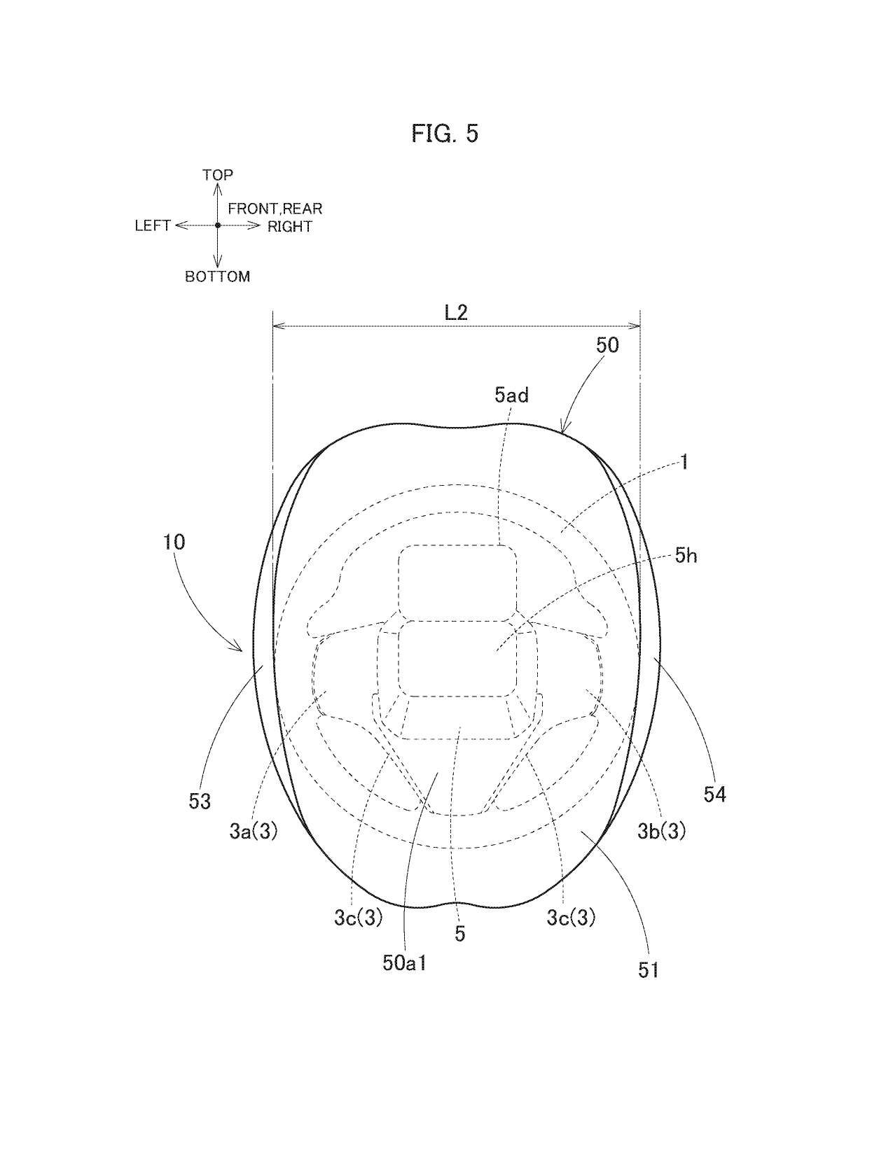

FIG. 1 is a view of the periphery of a driver's seat 39 of the vehicle 30 as viewed from the left side, and illustrates a driver M, who is an occupant seated on the driver's seat 39 by two-dot chain lines. FIG. 2 is a front view of the steering wheel 10 mounted on the vehicle 30. FIG. 3 is a cross-sectional view of the steering wheel 10 taken along line A-A illustrated in FIG. 2. FIG. 4 is a left side view of the steering wheel 10 in a state where the airbag 50 is completely inflated. FIG. 5 is a front view of the steering wheel 10 in a state where the airbag 50 is completely inflated.

Here, in the following description, unless otherwise specified, each of the front-rear direction, the top-bottom direction, and the left-right direction means a direction based on the vehicle 30 illustrated in FIG. 1. That is, the front-rear direction is the traveling direction of the vehicle 30 when the vehicle travels straight and the opposite direction. The left-right direction is a left direction and a right direction when the vehicle 30 travels straight, and can also be referred to as a vehicle width direction of the vehicle 30. The top-bottom direction is a vertical direction.

As illustrated in FIG. 1, the steering wheel 10 is connected to a steering shaft 35 of the vehicle 30. The vehicle 30 includes a steering column 36 including a column tube 36a that partially covers an outer peripheral portion of the steering shaft 35 to support the steering shaft 35, and a column cover 36b that covers a portion of the steering shaft 35 protruding rearward from an instrument panel 37. The steering wheel 10 is attached to a rear end portion 35a of the steering shaft 35 protruding rearward from the instrument panel 37.

As illustrated in FIGS. 2 to 5, the steering wheel 10 includes a grip portion 1 gripped by the driver M when the vehicle 30 is steered, a boss portion 2 connected to the steering shaft 35, and a spoke portion 3 connecting the grip portion 1 and the boss portion 2. In addition, the steering wheel 10 includes a pad 5 that covers the boss portion 2 from behind and constitutes a part of the exterior on the rear side of the steering wheel 10, a lower cover 6 that constitutes the exterior on the front side of the steering wheel 10, and an airbag unit 40 that has an airbag 50 and protects the driver M by the airbag 50.

The grip portion 1 includes a core material 1a including metal, an intermediate material 1b including synthetic resin such as polyurethane and covering the core material 1a, and a surface material 1c such as leather wound around an outer peripheral portion of the intermediate material 1b. The driver M grips the grip portion 1 and rotationally steers the grip portion 1 to rotate the steering shaft 35 and change the traveling direction of the vehicle 30. Note that in the present embodiment, the grip portion 1 has an annular shape, but may have another shape.

The boss portion 2 is a metal member connected to the steering shaft 35, and has a shaft hole 2a through which the steering shaft 35 is inserted. The boss portion 2 and the steering shaft 35 are connected by fixing the boss portion 2 and the steering shaft 35 to each other with a nut 38 in a state where the steering shaft 35 is inserted and fitted into the shaft hole 2a.

The spoke portion 3 includes a left spoke portion 3a and a right spoke portion 3b extending from the boss portion 2 to the left and right, respectively, and a lower spoke portion 3c extending downward. The spoke portion 3 includes a core material 3x1 including metal and connecting the core material 1a of the grip portion 1 and the boss portion 2, and a spoke cover 3x2 including resin and covering the core material 3x1. The core material 1a of the grip portion 1, the boss portion 2, and the core material 3x1 of the spoke portion 3 are integrally molded by die casting.

The pad 5 includes a substantially rectangular parallelepiped cover portion 5a that covers the rear of the airbag 50 in the folded state and constitutes a part of the exterior of the steering wheel 10, and a connecting portion 5b that extends forward from the cover portion 5a and is connected to a case 43 of the airbag unit 40. An insertion hole 5b1 through which the case 43 is inserted is formed on the front end side of the connecting portion 5b of the pad 5. Note that in the present embodiment, the pad 5 includes synthetic resin.

The cover portion 5a of the pad 5 is broken by the pressure received from the airbag 50 when the airbag 50 is inflated to form an opening 5h, and the airbag 50 is delivered from the opening 5h. The cover portion 5a has a substantially rectangular door portion 5ad that rotates upward at the time of breaking. The airbag 50 is inflated and comes into contact with the door portion 5ad, and the door portion 5ad rotates as described above, whereby the opening 5h is formed in the cover portion 5a. Note that the peripheral edge of the door portion 5ad of the cover portion 5a is a fragile portion, not illustrated, that is cut out from the back surface side to be thin so as to be easily broken when receiving pressure from the airbag 50.

The airbag unit 40 includes the airbag 50, an inflator 42 that supplies an inflation gas to the airbag 50, the case 43 that holds the airbag 50 and the inflator 42, and a retainer 44 used for fixing the airbag 50 and the inflator 42. Furthermore, the airbag unit 40 includes a control device, not illustrated, that controls the operation and the like of the inflator 42, and an acceleration sensor, not illustrated, used for collision detection of the vehicle 30. The control device and the acceleration sensor are disposed at predetermined positions inside the vehicle 30.

The inflator 42 is a member that has a substantially cylindrical shape and generates and releases the inflation gas. A discharge port 42a through which the inflation gas is discharged is provided on the rear side of the inflator 42. The portion of the inflator 42 where the discharge port 42a is formed is disposed inside the airbag 50. In addition, the inflator 42 includes, as a portion connected to the case 43, a flange portion 42b extending in the radial direction of the substantially cylindrical shape from a surface in which the discharge port 42a is formed. The inflator 42 is electrically connected to the control device, not illustrated, and operates when receiving a signal from the control device to generate the inflation gas and discharge the inflation gas from the discharge port 42a.

The airbag 50 is a bag-shaped member, and is housed inside the steering wheel 10 in a folded state, specifically, in the area between the pad 5 and the boss portion 2. On the front side of the airbag 50 in the folded state, a gas inlet 50h, which is an opening for inserting a portion of the inflator 42 where the discharge port 42a is formed, is formed.

The airbag 50 that is completely inflated includes a rear wall portion 50a1 disposed on the rear side and configured to receive the driver M, a front wall portion 50a2 disposed on the front side and supported in contact with the grip portion 1 of the steering wheel 10, a left wall portion 50a3 disposed on the left side, and a right wall portion 50a4 disposed on the right side. The airbag 50 that is completely inflated is configured to cover the entire area of the grip portion 1 of the steering wheel 10 from behind.

Furthermore, at a lower part of the left wall portion 50a3, a tuck 50a3a that narrows the width of the left wall portion 50a3 in the left-right direction by forming a fold is provided. At a lower part of the right wall portion 50a4, a tuck 50a4a that narrows the width in the left-right direction of the right wall portion 50a4 by forming a fold is provided. These tucks 50a3a and 50a4a are arranged at the same position in the left-right direction. In this manner, by narrowing the widths in the left-right direction of the lower portion of the left wall portion 50a3 and the lower portion of the right wall portion 50a4 by the tuck 50a3a and the tuck 50a4a, the airbag 50 can be easily inserted between the lower portion of the grip portion 1 of the steering wheel 10 and the chest of the driver M.

A tether 57 is provided inside the airbag 50. The tether 57 is a member that defines the width of the airbag 50 in the front-rear direction when the airbag 50 is completely inflated. The tether 57 is disposed so as to extend in the front-rear direction along the rotation axis R of the steering shaft 35 when the airbag 50 is completely inflated.

The case 43 includes sheet metal, and holds the airbag 50, the inflator 42, and the pad 5. The case 43 is fixed to the core material 3x1 of the spoke portion 3 with a pin of a horn switch unit, not illustrated, interposed therebetween. The case 43 includes a rectangular parallelepiped bottom wall portion 43a and a side wall portion 43b extending rearward from an outer edge of the bottom wall portion 43a. The bottom wall portion 43a has an insertion hole 43a1 through which the inflator 42 is inserted. The side wall portion 43b and the bottom wall portion 43a of the case 43 are sequentially inserted into the insertion hole 5b1 of the connecting portion 5b of the pad 5, and the connecting portion 5b is retained by the side wall portion 43b, whereby the pad 5 is held by the case 43.

The retainer 44 is a substantially square annular member including metal used for fixing the airbag 50 and the like, and is disposed inside the airbag 50. The retainer 44 has an insertion hole 44a through which the inflator 42 is inserted. In a case where the airbag 50 and the inflator 42 are fixed to the case 43, the inflator 42 is inserted into the insertion hole 43a1 of the case 43, the gas inlet 50h of the airbag 50, and the insertion hole 44a of the retainer 44, and a bolt 45 is inserted into screw holes formed in the peripheral edge of the gas inlet 50h of the airbag 50, the bottom wall portion 43a of the case 43, and the flange portion 42b of the inflator 42, respectively, and is fastened with a nut 46. As a result, the peripheral edge of the gas inlet 50h of the airbag 50 is sandwiched between the front surface of the retainer 44 and the rear surface of the bottom wall portion 43a of the case 43, and the flange portion 42b of the inflator 42 is sandwiched between the front surface of the bottom wall portion 43a and the nut 46. In this manner, the airbag 50 and the inflator 42 are fixed to the bottom wall portion 43a of the case 43.

When the airbag unit 40 protects the driver M, first, when a collision of the vehicle 30 occurs, an acceleration sensor, not illustrated, detects this collision as acceleration. When the acceleration detected by the acceleration sensor is equal to or greater than a predetermined value, the control device, not illustrated, determines that the vehicle 30 has collided and transmits an operation signal to the inflator 42.

The inflator 42 then operates to release the inflation gas. As a result, the inflation gas is supplied into the airbag 50, and the airbag 50 is inflated. Thereafter, the driver M who moves forward due to the impact of the collision of the vehicle 30 and is about to collide with the grip portion 1 of the steering wheel 10, is received by the rear wall portion 50a1 of the airbag 50 and protected.

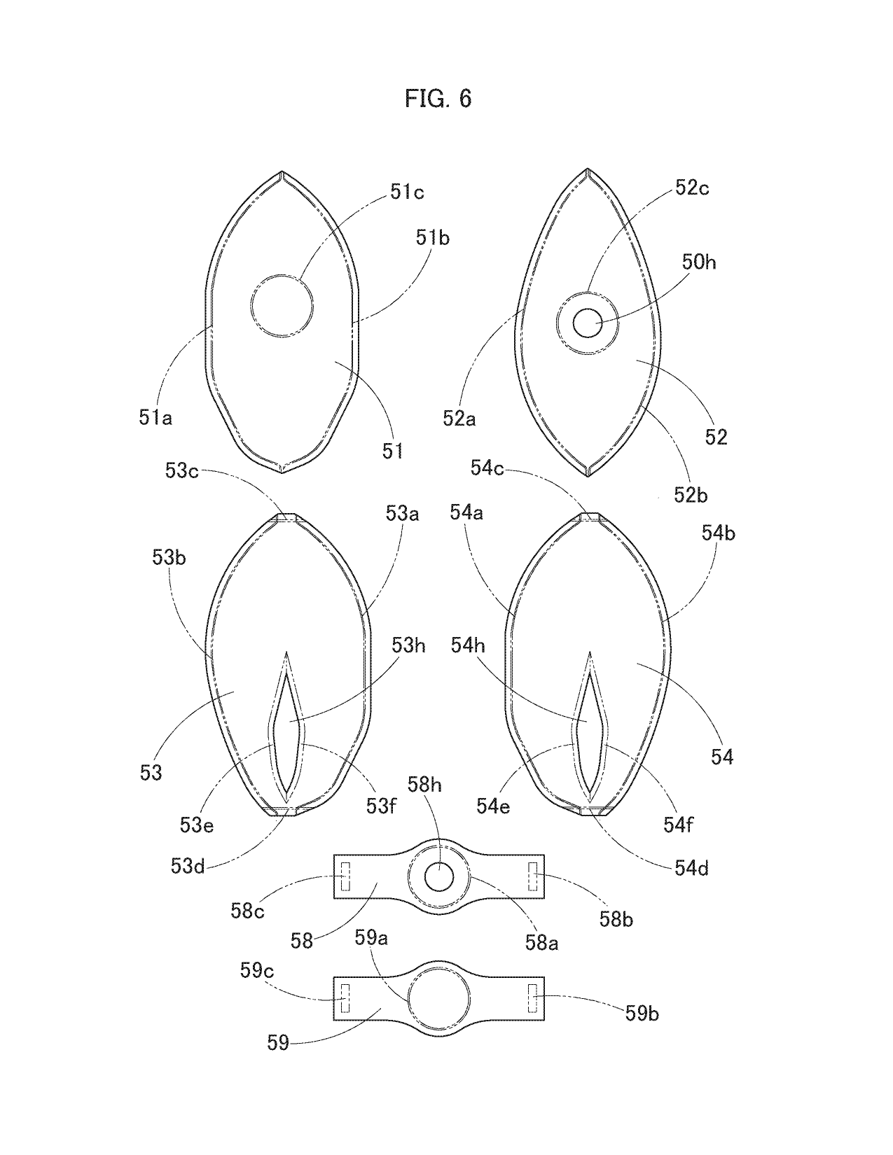

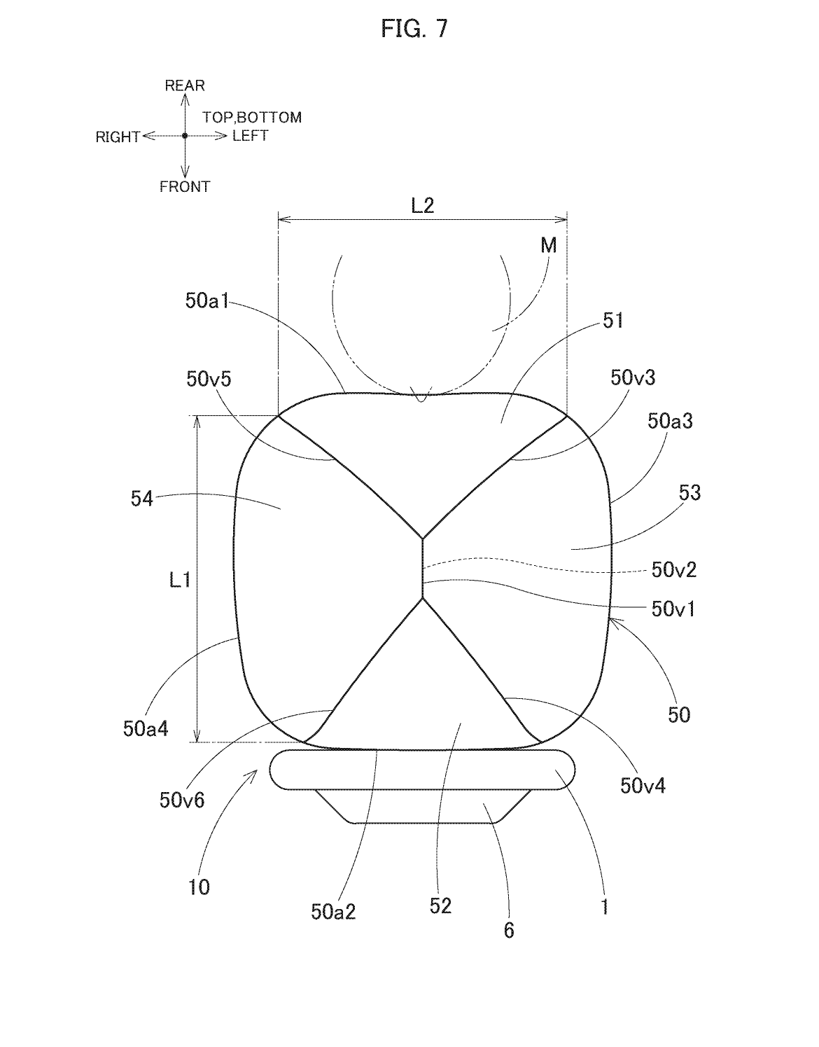

Next, a detailed configuration of the airbag 50 will be described. FIG. 6 is a plan view of each panel constituting the airbag 50. FIG. 7 is a plan view of the steering wheel 10 in a state where the airbag 50 is completely inflated, and the face of the driver M is indicated by two-dot chain lines.

As illustrated in FIG. 6, the airbag 50 is formed in a bag shape by sewing peripheral edges of four panels, that is, a rear wall panel 51, a front wall panel 52, a left wall panel 53, and a right wall panel 54. Each of the rear wall panel 51, the front wall panel 52, the left wall panel 53, and the right wall panel 54 of the present embodiment includes a flexible woven fabric made of a polyester thread or the like.

The rear wall panel 51 (occupant-side panel) is a panel that constitutes the rear wall portion 50a1 when the airbag 50 is completely inflated. Therefore, it can be said that the rear wall panel 51 is a panel that is disposed on the rear side when the airbag 50 is completely inflated and is configured to receive the driver M.

The front wall panel 52 (steering wheel-side panel) is a panel that constitutes the front wall portion 50a2 when the airbag 50 is completely inflated. Therefore, it can be said that the front wall panel 52 is a panel that is disposed on the front side when the airbag 50 is completely inflated and is supported in contact with the grip portion 1 of the steering wheel 10. The front wall panel 52 has the gas inlet 50h which is an opening through which the inflator 42 is inserted.

The left wall panel 53 (side panel, left side panel) is a panel that constitutes the left wall portion 50a3 when the airbag 50 is completely inflated. When the airbag 50 is formed in a bag shape, the left wall panel 53 is sewn to a portion 51a to be sewn of the rear wall panel 51 at a portion 53a to be sewn, and is sewn to a portion 52a to be sewn of the front wall panel 52 at a portion 53b to be sewn. In addition, the left wall panel 53 and the right wall panel 54 are connected by sewing a portion 53c to be sewn of the left wall panel 53 and a portion 54c to be sewn of the right wall panel 54 and by sewing the a portion 53d to be sewn of the left wall panel 53 and a portion 54d to be sewn of the right wall panel 54. Therefore, it can be said that the left wall panel 53 is a panel that is disposed on the left side when the airbag 50 is completely inflated, is sewn to the rear wall panel 51, the front wall panel 52, and the right wall panel 54, and connects the rear wall panel 51 and the front wall panel 52.

Here, the portion 53a to be sewn of the left wall panel 53 and the portion 51a to be sewn of the rear wall panel 51 have the same curvature. Similarly, the portion 53b to be sewn of the left wall panel 53 and the portion 52a to be sewn of the front wall panel 52 have the same curvature. As a result, when the left wall panel 53 and the rear wall panel 51 are sewn or when the left wall panel 53 and the front wall panel 52 are sewn, they can be sewn in a planar manner, so that work efficiency can be improved. Note that the tuck 50a3a of the left wall portion 50a3 is formed by sewing a portion 53e to be sewn and a portion 53f to be sewn on the peripheral edge of a through hole 53h formed in the left wall panel 53 while pinching the left wall panel 53.

The right wall panel 54 (side panel, right side panel) is a panel that constitutes the right wall portion 50a4 when the airbag 50 is completely inflated. When the airbag 50 is formed in a bag shape, the right wall panel 54 is sewn to a portion 51b to be sewn of the rear wall panel 51 at a portion 54a to be sewn, and is sewn to a portion 52b to be sewn of the front wall panel 52 at a portion 54b to be sewn. In addition, as described above, the left wall panel 53 and the right wall panel 54 are connected by sewing the portion 53c to be sewn of the left wall panel 53 and the portion 54c to be sewn of the right wall panel 54 and by sewing the portion 53d to be sewn of the left wall panel 53 and the portion 54d to be sewn of the right wall panel 54. Therefore, it can be said that the right wall panel 54 is a panel that is disposed on the right side when the airbag 50 is completely inflated, is sewn to the rear wall panel 51, the front wall panel 52, and the left wall panel 53, and connects the rear wall panel 51 and the front wall panel 52.

Here, the portion 54a to be sewn of the right wall panel 54 and the portion 51b to be sewn of the rear wall panel 51 have the same curvature. Similarly, the portion 54b to be sewn of the right wall panel 54 and the portion 52b to be sewn of the front wall panel 52 have the same curvature. As a result, when the right wall panel 54 and the rear wall panel 51 are sewn or when the right wall panel 54 and the front wall panel 52 are sewn, they can be sewn in a planar manner, so that work efficiency can be improved. Note that the tuck 50a4a of the right wall portion 50a4 is formed by sewing a portion 54e to be sewn and a portion 54f to be sewn on the peripheral edge of a through hole 54h formed in the right wall panel 54 while pinching the right wall panel 54.

The tether 57 provided inside the airbag 50 includes a front tether panel 58 and a rear tether panel 59. The front tether panel 58 has an insertion port 58h which is an opening for inserting a portion of the inflator 42 where the discharge port 42a is formed. When the airbag 50 is completely inflated, the front tether panel 58 is disposed in front of the rear tether panel 59. Note that in the present embodiment, each of the front tether panel 58 and the rear tether panel 59 includes a flexible woven fabric made of a polyester thread or the like.

When the airbag 50 is formed in the bag shape, the front tether panel 58 is sewn to a portion 52c to be sewn of the front wall panel 52 at a portion 58a to be sewn, and the rear tether panel 59 is sewn to the portion 51c to be sewn of the rear wall panel 51 at a portion 59a to be sewn. In addition, the front tether panel 58 and the rear tether panel 59 are connected by sewing a portion 58b to be sewn of the front tether panel 58 and a portion 59b to be sewn of the rear tether panel 59 and by sewing a portion 58c to be sewn of the front tether panel 58 and a portion 59c to be sewn of the rear tether panel 59. In this manner, the rear wall panel 51, the front wall panel 52, the left wall panel 53, the right wall panel 54, the front tether panel 58, and the rear tether panel 59 are connected to form the airbag 50 in a state before being folded.

Here, in the present embodiment, as illustrated in FIG. 7, in a state where the airbag 50 is completely inflated, a width L1 of each of the left wall panel 53 and the right wall panel 54 in the front-rear direction along the rotation axis R of the steering shaft 35 is larger than a width L2 of the rear wall panel 51 in the left-right direction (see also FIGS. 4 and 5). Accordingly, the following effects are obtained.

That is, if the width L1 is narrower than the width L2, in a case where the weight of the driver M is heavy or in a case where the speed at the time of collision of the vehicle 30 is high, the airbag 50 is deformed so that the width in the front-rear direction is greatly reduced by the forward load input to the airbag 50 when the driver M is received, and so-called bottoming in which the driver M comes into contact with the grip portion 1 of the steering wheel 10 with the airbag 50 interposed therebetween is likely to occur. The term "bottoming" as used herein means that the rear wall portion 50a1 that has received the driver M comes into contact with the front wall 50a2, whereby the driver M comes into contact with the grip portion 1 of the steering wheel 10 with the rear wall portion 50a1 and the front wall portion 50a2 interposed therebetween.

On the other hand, in the present embodiment, since the width L1 is larger than the width L2, the allowable deformation amount of the airbag 50 in the front-rear direction until bottoming occurs can be set large. Therefore, even in a case where the airbag 50 is deformed so that the width in the front-rear direction is greatly reduced by the forward load input to the airbag 50 when the driver M is received, bottoming is less likely to occur. Therefore, according to the airbag 50 of the present embodiment, it is possible to prevent the driver M from coming into contact with the grip portion 1 of the steering wheel 10 with the airbag 50 interposed therebetween in a collision of the vehicle 30.

Further, when the airbag 50 is completely inflated, a sewn portion 50v1 between the left wall panel 53 and the right wall panel 54 formed by sewing the portion 53c to be sewn of the left wall panel 53 and the portion 54c to be sewn of the right wall panel 54 extends in the front-rear direction along the rotation axis R of the steering shaft 35. Similarly, when the airbag 50 is completely inflated, a sewn portion 50v2 between the left wall panel 53 and the right wall panel 54 formed by sewing the portion 53d to be sewn of the left wall panel 53 and the portion 54d to be sewn of the right wall panel 54 extends in the front-rear direction along the rotation axis R of the steering shaft 35. Note that the sewn portion 50v2 is positioned directly below the sewn portion 50v1 when the airbag 50 is completely inflated.

Since the sewn portions 50v1 and 50v2 extend along the front-rear direction along the rotation axis R of the steering shaft 35 in this manner, when the airbag 50 is to be deformed so that the width in the front-rear direction is reduced by the forward load input to the airbag 50 when the driver M is received, tension acting to suppress the deformation is likely to occur in the left wall panel 53 and the right wall panel 54. Therefore, it is possible to more effectively prevent the driver M from coming into contact with the grip portion 1 of the steering wheel 10 with the airbag 50 interposed therebetween in a collision of the vehicle 30.

Note that the configuration herein in which the sewn portions 50v1 and 50v2 extend along the front-rear direction along the rotation axis R of the steering shaft 35 includes, in addition to the configuration in which the sewn portions 50v1 and 50v2 linearly extend in the front-rear direction along the rotation axis R of the steering shaft 35, a configuration in which the sewn portions 50v1 and 50v2 linearly extend while being shifted in a range of ±20 degrees in the left-right direction or the top-bottom direction from the front-rear direction along the rotation axis R of the steering shaft 35. In addition, the configuration herein in which the sewn portions 50v1 and 50v2 linearly extend includes a configuration in which each of the sewn portions 50v1 and 50v2 is linearly sewn as a whole even if the stitches have a zigzag shape.

Note that, in the airbag 50, the portion 53a to be sewn of the left wall panel 53 and the portion 51a to be sewn of the rear wall panel 51 are sewn to form a sewn portion 50v3, and the portion 53b to be sewn of the left wall panel 53 and the portion 52a to be sewn of the front wall panel 52 are sewn to form a sewn portion 50v4. In addition, in the airbag 50, the portion 54a to be sewn of the right wall panel 54 and the portion 51b to be sewn of the rear wall panel 51 are sewn to form a sewn portion 50v5, and the portion 54b to be sewn of the right wall panel 54 and the portion 52b to be sewn of the front wall panel 52 are sewn to form a sewn portion 50v6.

What is claimed is:

1. An airbag mounted on a steering wheel including a grip portion gripped by an occupant and a boss portion connected to a steering shaft of a vehicle, the airbag being inflated by being supplied with an inflation gas, and covering an entire area of the grip portion from behind when the airbag is completely inflated, the airbag that is completely inflated comprising:
an occupant-side panel that is disposed on a rear side and is configured to receive the occupant;
a steering wheel-side panel that is disposed on a front side and is supported in contact with the grip portion; and
a side panel that is sewn to the occupant-side panel and the steering wheel-side panel and connects the occupant-side panel and the steering wheel-side panel,
wherein a width of the side panel in a front-rear direction along a rotation axis of the steering shaft is larger than a width of the occupant-side panel in a left-right direction.

2. The airbag according to claim 1,
wherein the side panel includes:
a left side panel that is disposed on a left side and is sewn to the occupant-side panel and the steering wheel-side panel to connect the occupant-side panel and the steering wheel-side panel; and
a right side panel that is disposed on a right side, is configured separately from the left side panel, and is sewn to the occupant-side panel, the steering wheel-side panel, and the left side panel to connect the occupant-side panel and the steering wheel-side panel, and
a sewn portion between the left side panel and the right side panel extends along the front-rear direction along the rotation axis.
